(19) United States
(12) Patent Application Publication
(10) Pub. No.: US 2025/0005046 A1
(43) Pub. Date: Jan. 2, 2025

(54) Database with Integrated Generative AI

(71) Applicant: Formagrid Inc, San Francisco, CA (US)

(72) Inventors: Sean William Keenan, Millbrae, CA (US); Jerry Hong, New York, NY (US); Howard Thomas Liu, Beverly Hills, CA (US); Anthony H. Maggio, San Francisco, CA (US); Emily Yiming Cai, San Mateo, CA (US)

(21) Appl. No.: 18/756,986

(22) Filed: Jun. 27, 2024

Related U.S. Application Data
(60) Provisional application No. 63/523,588, filed on Jun. 27, 2023.

(51) Int. Cl. G06F 16/28; G06F 16/26

(52) U.S. Cl. CPC G06F 16/288

(57) ABSTRACT

A system and method for managing, categorizing and manipulating data within a server environment utilizing a user interface, a generative AI field in database, and database datastores. The generative AI field accepts natural language requests from a user and determines appropriate prompts for a generative AI model. The generated prompt is configured to generate data providing the functionality specified in the natural language request. The functionality may include categorizing data, generating fields in a database, assisting prompt generation and producing functions for further data manipulation.

### CROSS-REFERENCE TO RELATED APPLICATIONS

This application claims the benefit of U.S. Provisional Application No. 63/523,588, filed Jun. 27, 2023, which is hereby incorporated by reference in their entirety.

### BACKGROUND

### 1. Technical Field

The subject matter described relates generally to databases and, in particular, to incorporating generative artificial intelligence (“AI”) into databases.

### 2. Background Information

Generative AI is a powerful tool, but it can be difficult to integrate into complex, chained workflows. Existing solutions add generative AI in an open-ended fashion through existing formula functions. These solutions, while possible to integrate into existing workflows, do not do so in a structured fashion. Neither the data consumed nor the manner of integration into workflows to solve problems adopt a coherent structural approach. Consequently, it is difficult to configure the generative AI using such approaches making them non-scalable,

### SUMMARY

A database solution provides a generative AI field type. A generative AI field is able to integrate with a range of other primitives, such as automations, syncing, or interfaces, etc. In various embodiments, a generative AI field can have a prompt building experience guided based on many potential inputs, such one or more of: as contextual information from the database, contextual information about the user, or explicit user selection from preconfigured options. The use of context-specific inputs can provide improved results from the generative AI than is achieved with a user-provided prompt alone.

In some embodiments, the prompt building experience includes presenting the user with suggestions on how to build a better prompt by running a generative AI prompt against an initial prompt to offer specific suggestions with contextual information about the database or user. The user may also be able to automatically run multiple generated variations of suggested prompts and compare the results. Human edited content may be captured and used to retrain the generative AI model or improve prompt engineering. For example, the prompt building experience may provide the user with previously human edited example that can be fed into the generative model directly. These human edited examples can be selected using either a generative text model or embedding model to select maximally different examples. Maximally categorically different examples typically result in the best generative text model output.

The capture of human edited content may also allow back testing to be done where (especially with large language models tuned to be fully deterministic) new prompts can be statically analyzed against a user's data (including human edited content) to ensure it is performing better. Since data is generally “human scale,” adding a human in the loop enable cases where the generative AI generates new or substantively different results to be rated (e.g., highlighting to the user the most different results).

In some embodiments, AI may also be used for database categorization using vector embeddings. This allows for structured databases to automatically have categorizations applied to them. Adding new categories is cheap because computing the initial vector embedding is expensive, but finding the nearest neighbor is cheap. By identifying clusters using K-means clustering or a similar approach, new cluster names can be proposed. In some cases, recommended names may be generated for all clusters (by reversing the most centrally weighted point in each cluster and finding the most closely associated text). Cluster names can also be updated by suggesting new text for clusters that is more central to the existing cluster associated with that text.

In some aspects, the techniques described herein relate to a computer-implemented method for generating data for a base, the computer-implemented method including: receiving, by a computing device, a request to generate a set of data providing a functionality in a base including structured data, the request including a natural language request for the functionality using a least a portion of the structured data of the base; determining, by the computing device, a prompt for a large language model to generate the set of data providing the functionality, wherein the prompt including a representation of: the natural language request for the functionality; the portion of the structured data used in the natural language request, a structure of the base; structural relationships in the base; and data types of the structured data in the base; in response to transmitting the prompt to the large language model, receiving, by the computing device, the set of data providing the functionality from the large language model; and transmitting the set of data for display as structured data in the base.

In some aspects, the techniques described herein relate to a computer-implemented method, including determining, using the prompt at a network system hosting the large language model, the set of data providing the functionality, the large language model configured to: interpret the natural language request for the functionality using at least the structured data, identify contextual relationships between the functionality and one or more of the structure of the structured data, the structural relationships of data in the structured data, and data types of the structured data, and determine the set of data providing the functionality based on the contextual relationships.

In some aspects, the techniques described herein relate to a computer-implemented method, further including: receiving, by the computing device, a selection of the large language model from a plurality of large language models, wherein the plurality of large language models is provided to a client device generating the prompt; and wherein generating the prompt for the large language model accounts for a configuration of the selected large language model.

In some aspects, the techniques described herein relate to a computer-implemented method, wherein the natural language request includes one or more data objects representing the portion of the structured data of the base.

In some aspects, the techniques described herein relate to a computer-implemented method, including: receiving, at the computing device, an edit to the set of data displayed as structured data of the base; generating, at the computing device, a flag for the set of data as manipulated data based on the edit. responsive to receiving an additional request to modify the set of data, determining an additional prompt and modifying the set of data based on the generated flag.

In some aspects, the techniques described herein relate to a computer-implemented method, wherein the structure of the structured data includes one or more of: a plurality of elements in the base, each element including structured data; a set of rows in the base, the set of rows including one or more of the plurality of elements; a set of fields in the base, the set of fields including one or more of the plurality of elements; a label for each element of the plurality of elements, each row of the set of rows, and each field of the set of fields; and a size of the base.

In some aspects, the techniques described herein relate to a computer-implemented method, wherein the base includes a plurality of elements in a set of fields and a set of rows, and the structural relationships of data in the structured data include one or more of: a dependency of a first field in the set of fields on a second field in the set of fields; a dependency of a first row in the set of rows on a second row in the set of rows; a dependency of a first element of the plurality of elements on a second element of the plurality of elements; and one or more logical functions governing dependencies in the structural data.

In some aspects, the techniques described herein relate to a computer-implemented method, wherein the prompt includes a relationship between the base and one or more additional bases; wherein each of the one more additional bases depend on structured data of the base.

In some aspects, the techniques described herein relate to a computer-implemented method, wherein the set of data is propagated to the one or more additional bases that depend on the structured data of the base.

In some aspects, the techniques described herein relate to a computer-implemented method, wherein the prompt includes a representation of a relationship between the base and one or more additional bases; wherein the structured data of the base depend on structured data of the one or more additional bases.

In some aspects, the techniques described herein relate to a computer-implemented method, wherein the set of data is propagated to the one or more additional bases that depend on the structured data of the base.

In some aspects, the techniques described herein relate to a computer-implemented method, wherein: the base includes a field, and the request to generate the set of data providing the functionality in the base is received as an input to the field; and the generated prompt is associated with the field.

In some aspects, the techniques described herein relate to a computer-implemented method, wherein the received set of data is displayed in the field before being displayed as structured data in the base.

In some aspects, the techniques described herein relate to a computer-implemented method, wherein the base includes a data generation assistant function, and the request to generate the set of data providing the functionality in the base is received at the data generation assistant.

In some aspects, the techniques described herein relate to a computer-implemented method, wherein the received set of data is displayed by the data generation assistant function before being displayed as structured data in the base.

In some aspects, the techniques described herein relate to a computer-implemented method, wherein the functionality is categorizing data input into the base.

In some aspects, the techniques described herein relate to a computer-implemented method, wherein the functionality is generating a function that manipulates a first portion of the structured data in the base based on a second portion of the structured data in the base.

In some aspects, the techniques described herein relate to a computer-implemented method, wherein the functionality is translating a first portion of the structured data in the base.

In some aspects, the techniques described herein relate to a system including: one or more processors; and a non-transitory computer readable storage medium including computer program instructions for generating data for a base, the computer program instructions, when executed by the one or more processors, causing the one or more processors to: receive, at the system, a request to generate a set of data providing a functionality in a base including structured data, the request including a natural language request for the functionality using a least a portion of the structured data of the base; determine, by the system, a prompt for a large language model to generate the set of data providing the functionality, wherein the prompt including a representation of: the natural language request for the functionality; the portion of the structured data used in the natural language request, a structure of the base; structural relationships in the base; and data types of the structured data in the base; in response to transmitting the prompt to the large language model, receive, at the system, the set of data providing the functionality from the large language model; and transmit, to a client device, the set of data for display as structured data in the base.

In some aspects, the techniques described herein relate to a non-transitory computer readable storage medium including computer program instructions for generating data for a base, the computer program instructions, when executed by the one or more processors, causing the one or more processors to: receive, at a computing device, a request to generate a set of data providing a functionality in a base including structured data, the request including a natural language request for the functionality using a least a portion of the structured data of the base; determine, at the computing device, a prompt for a large language model to generate the set of data providing the functionality, wherein the prompt including a representation of: the natural language request for the functionality; the portion of the structured data used in the natural language request, a structure of the base; structural relationships in the base; and data types of the structured data in the base; in response to transmitting the prompt to the large language model, receive, at the computing device, the set of data providing the functionality from the large language model; and transmit, to a client device, the set of data for display as structured data in the base.

### BRIEF DESCRIPTION OF THE DRAWINGS

Figure (“FIG.”) 1 a networked computing environment suitable for hosting databases with integrated generative artificial intelligence, according to one embodiment.

FIG. 2 illustrates a box diagram of the server, according one embodiment.

FIG. 3A illustrates a dependency of two tables of two databases in the bases datastore, according to one embodiment.

FIG. 3B illustrates a dependency of two tables of two databases in the bases datastore, according to one embodiment.

FIG. 3C illustrates a dependency of a single table in a data base on two tables of two databases in the bases datastore, according to one embodiment.

FIG. 4 illustrates a first example workflow diagram for a computer-implemented method for generating data for a base, according to one embodiment.

FIG. 5 is a block diagram of an example computer suitable for use as a server or client device, according to one embodiment.

### DETAILED DESCRIPTION

The figures and the following description describe certain embodiments by way of illustration only. One skilled in the art will readily recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

### Example Systems

Figure (“FIG.”) 1 a networked computing environment suitable for hosting databases with integrated generative artificial intelligence (“AI”), according to one embodiment. In the embodiment shown, the networked computing environment 100 includes a server 110 and a set of client devices 140A-N, all connected via a network 170. Although three client devices 140 are shown, it should be appreciated that any number of such devices may be in the networked computing environment 100. In other embodiments, the networked computing environment 100 includes different or additional elements. In addition, the functions may be distributed among the elements in a different manner than described. For example, the databases may be hosted by a different server than the generative AI model.

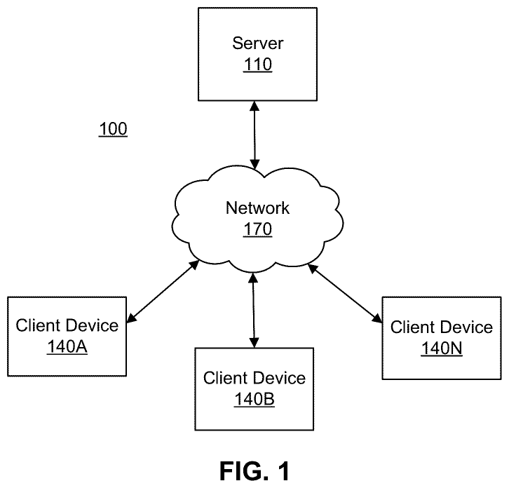

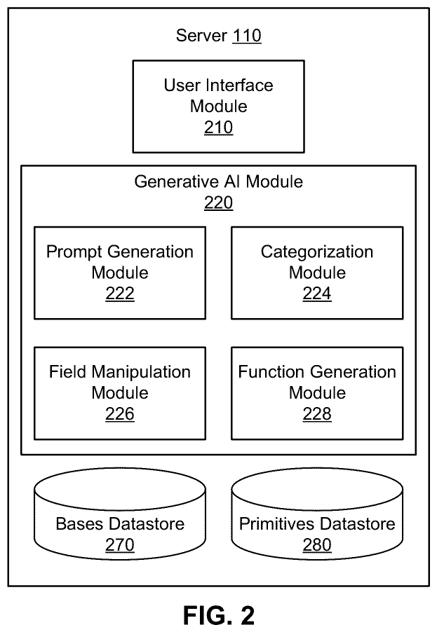

The server 110 includes on or more computing devices that provide services to the client devices 140. The server 110 hosts multiple databases. The databases can include fields having a generative AI type that enable generative AI to be incorporated into the databases. This can aid in incorporating generative AI content into existing workflows. For example, in one embodiment, a user can provide structured information about a job posting, such as a title, seniority, and location, etc., and a generative AI field is automatically filled with a natural language description of the job. In addition to the structured data provided by the user, the generative AI model may also take additional contextual information as input, such as other data in the same database, information about the submitting user, or the like. If the user makes a change to any of the structured information (e.g., changing the seniority of the job) then the natural language description may be automatically regenerated. The user can make edits to the natural language description generated by the model. Any edits made may be used to retrain the model or provide recommendations for edits in future. Various embodiments of the server 110 are described in greater detail below, with reference to FIG. 2.

The client devices 140 are computing devices with which users can interact with the server 110. In one embodiment, a user uses an app or other software to access one or more databases hosted by the server 110. Using controls provided within the software, a user can create, manage, edit, and query, etc., a database. For example, the user may add a generative AI field, specify a set of inputs, and provide data for those inputs. The generative AI field sends the input data to a generative AI model (which may be hosted on the server 110 or accessed remotely via the network 170) with the generated results being presented to the user in the generative AI field.

The network 170 provides the communication channels via which the other elements of the networked computing environment 100 communicate. The network 170 can include any combination of local area and wide area networks, using wired or wireless communication systems. In one embodiment, the network 170 uses standard communications technologies and protocols. For example, the network 170 can include communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 170 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 170 may be represented using any suitable format, such as hypertext markup language (HTML) or extensible markup language (XML). In some embodiments, some or all of the communication links of the network 170 may be encrypted using any suitable technique or techniques.

FIG. 2 illustrates a box diagram of the server, according one embodiment. In the embodiment shown, the server 110 includes a user interface module 210, and generative AI (“Gen-AI”) module 220, a bases datastore 270, and a primitives datastore 280. The Gen-AI module 220 may include a prompt generation module 222, a categorization module 224, a field manipulation module 226, and a function generation module 228. In other embodiments, the server 110 includes different or additional elements. In addition, server 110 functionality may be distributed among the elements in a different manner than described.

The user interface module 210 provides a user interface with which users may interact with databases in the bases datastore 270 (e.g., using a client device 140 connected to the server 110 via the network 170). The databases may be permissioned such that a user can only view and edit databases (or portions of databases) that their credentials authorize. For example, one user may be able to define and add generative AI fields to a database while another may only be able to enter structured data that is provided as input to a generative AI model with the output of the model being displayed in the generative AI field. It should be appreciated that a wide range of database and permissions structures may be used within this framework, some of which are described hereinbelow. For instance, a user may have permission to edit generated AI data, but may not have permission to see or edit the underlying data.

At a high level, the generative AI module (“Gen-AI”) 220 manages generative AI fields in databases (e.g., generative AI fields in a database, an assistant function that applies AI functionality to fields in a database, etc.). In one embodiment, a generative AI field (or AI assistant) takes an input and generates a prompt for a generative AI model based on the input. The AI model generates response information (e.g., a set of data) to the prompt, and the generative AI module 220 causes display of the responsive information in a visual representation of the generative AI field (e.g., by providing the responsive information to a client device 140 of the user). The input may be a natural language prompt or a natural language input used to generate a prompt. The generative AI model may be a large language model such as a Generative Pre-trained Transformer, or some other model (“GPT”). The responsive information may be text generated by the AI model, or some other output generated by the generative AI module based on the output by the generative AI module.

Providing more detail, the Gen-AI module 220 receives a request to generate a set of data providing a functionality in a base comprising structured data. The request is typically a natural language input received from, e.g., a client device 140. For example, the request may be a natural language sentence, paragraph, etc. The functionality is some function that the server 110 is configured to perform on databases (e.g., bases) or using bases in the environment 100. For example, the functionality may be a mathematical function, a search function, a comparison function, or some other function.

To provide a contextual example, the Gen-AI module 220 may receive a natural language input of “Translate the English text in Field 1 of Base 1 into Spanish in Field 2 of Base 1.” In this example, the functionality is translation from English to Spanish. The base is “Base 1” which is a structured data object stored in the bases datastore 270. From the input, it is apparent that Base 1 is structured to include at least Field 1. Presumably, Field 2 is also included in Base 1, or the Gen-AI module 220 may create Field 2. In turn, the Gen-AI module 220 generates a set of data to provide the requested function—e.g., the translation of the English in Field 1 into Spanish in Field 2 of Base 1. In some examples, the Gen-AI module configures the created Field 2 for all present or future data. In that way, the new Field 2 acts as a normal field within Base 1.

As alluded to above, the request for functionality may include at least a portion of the structured data of the base. That is, at least some portion of the natural language request may refer to at least some of the data in the structured data object of the base. The request may refer to, for instance, a particular element of data, a data field (e.g., a column), a row, a data type, a relationship or dependency between data in the base, a label to any of the aforementioned, etc. As such, the request for functionality may contextually include information from within the base itself. That is, the request may contextually include, e.g., the label, the data, the structure, relationships, etc. for the referenced portion of the structured data, or the base itself.

In some configurations, the Gen-AI module 220 may provide an autocomplete or predictive text functions as the server 110 receives the input, and, in some instances, the Gen-AI module 220 may provide entity recognition or named entity recognition based on the input. For example, in the previous example, as the natural language input of “Field 1” is received by the server 110, the Gen-AI module 220 may provide a data object representing Field 1 that replaces the text “Field 1” or links a data object to the text “Field 1.” The data object may carry with it any of the data and metadata of the entity.

The Gen-AI module 220 determines a prompt for a Gen-AI model based on the received request. The generated prompt is configured to generate a response providing the functionality defined in the natural language request. The Gen-AI module 220 may apply one or more models (e.g., a small language model, Markov chain, recurrent neural network, a large language model, etc.) to the natural language request to determine the prompt. In some configurations, the Gen-AI module stores the prompt as a string which is transmitted to the Gen-AI model and the Gen-AI model encodes the prompt into the model. In some cases, the Gen-AI module 220 may encode the generated prompt for transmission to the Gen-AI model. In either case, the encoded prompt is generally an embedding representing the prompt that is readable by the Gen-AI model.

In some configurations, the prompt may also be configured to include additional information relevant to determining a prompt that will generate the set of data providing the requested functionality. For example, the prompt may also be configured to include additional information with one or more of: (1) a portion or all of the structured data of the base, (2) the portion of data referred to in the natural language request, (3) a structure of the base (e.g., a structure of the structured data object forming the base), (4) structural relationships of in the base, (5) data types of the structured data in the base, (6) if data is required in order to generate responses (e.g., if the data is not present the Gen-AI module 220 may wait for it to be generated or input before giving a response), (8) if the output should be constrained (e.g., the prompt may be configured to generate a specific list of strings, booleans, numbers, etc.), (9) if the prompt should be conditionally modified deterministically based on data in the base (e.g., if, and only if, a field field is populated, prepend it with additional user provided data), (10) prompt information that the an entity within the environment provides for applying to all prompts (11) labels representing any of the above, etc.

To provide additional context, a base is a structured data object (e.g., a database) stored in the bases datastore 270. Structured data means that the base comprises an inherent structure that governs how data is stored in the base, how data is interrelated within the base, how the base or data within the base may be dependent on other structured data, etc. In other words, the structured data of the base has a structure. Oftentimes the structure includes an array of elements, each of which can include an element of data. The elements are sorted into fields (e.g., columns) and rows. Each column may include one or more types of data, and each row many include one or more types of data. Each field may have a label, and each row may have a label. The structure includes a number of structural relationships. The structural relationships define, e.g., a dependency of between elements, rows, and/or fields, one or more logical functions defining the dependency between elements rows and/or fields, a dependency on one or more additional bases, a dependency from one or more additional bases, etc. Thus, the additional information that may be encoded into a prompt may be information describing the structure and function of the base. In this way, the Gen-AI module 220 can generate a prompt with a higher probability of providing a set of data that achieves the requested functionality.

The Gen-AI module 220 transmits the prompt to the Gen-AI model. In various configurations, the Gen-AI model may be located on the server 110, a client device 140, or some other third-party system in or connected to the environment 100. In some configurations an entity submitting the request to the server 110 (e.g., a client device 140) may select the Gen-AI model (e.g., from a list of Gen-AI models) to which the prompt will be submitted. In this case, the Gen-AI module 220 may generate a prompt configured for that model.

In one or more embodiments, the Gen-AI model is a large language model (“LLM”) trained on a large corpus of training data to generate outputs for the requests for functionality. An LLM may be trained on massive amounts of text data, often involving billions of words or text units. The large amount of training data from various data sources allows the LLM to generate outputs for many tasks. An LLM may have significant number of parameters in a deep neural network (e.g., transformer architecture), for example, at least 1 billion, at least 15 billion, at least 135 billion, at least 175 billion, at least 500 billion, at least 1 trillion, or at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the server 110 or one or more entities different from the server 110. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

As described above, the server 110 generates and encodes prompts for a Gen-AI model based on the natural language request input data and information describing the base. When the Gen-AI model is an LLM encoding the prompt may include encoding the prompt as a set of input tokens. Similarly, the set of data providing the output functionality may be encoded as a set of output tokens. Each token in the set of input tokens or the set of output tokens may correspond to a text unit. For example, a token may correspond to a word, a punctuation symbol, a space, a phrase, a paragraph, an element, field, or row in the base, a structure of the base, data in the base, etc. For an example query processing task, the language model may receive a sequence of input tokens that represent a query and generate a sequence of output tokens that represent a response to the query. For a translation task, the transformer model may receive a sequence of input tokens that represent elements in a field in German and generate a sequence of output tokens that represent a translation of the elements in the field in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like. Additionally, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

Overall, the Gen-AI model generates a set of data providing the requested functionality and provides the set of data to the Gen-AI module 220. The Gen-AI module 220, depending on the configuration, may apply one or more logical functions or models to the received set of data such that it is suitable for presentation in the base. For example, the Gen-AI module 220 may apply the one or more mathematical functions defined in the response data in the base in a manger that prepares the set of data for presentation in the base.

The Gen-AI module 220 provides the set of data for display. For instance, the Gen-AI module 220 may append the data to a base and provide the base for display on a client device 140. In other examples, the Gen-AI module 220 may modify one or more elements, fields, rows, dependencies, functions, etc., based on the output of the Gen-AI model, and a client device 140 may access that base to view the data.

Within the functional context provided above, the prompt generation module 222, the categorization module 224, the field manipulation module 226, and the function generation module 228 are all configured to generate prompts that generate particular outputs by leveraging the functionality of the Gen-AI module 220. The Gen-AI module 220 may take into account the corresponding functionality of each module when generating the prompts for each module.

The server 110 includes a prompt generation module 222. The prompt generation module 230 provides a guided approach to prompt generation by the user. That is, the server 110 may receive a natural language request to aid in generating a prompt or improved prompt for a desired functionality (e.g., “a prompt request”). Thus, the requested functionality is generating a prompt request-which is a prompt or improved prompt suitable for determining a set of data that provides the requested functionality (which may be different than the prompt request). The prompt request may be provided in a field of the base by a user operating a client device 140. Again, the prompt request may be generated based on a portion of the structured data included in the base, for instance by combining (e.g., concatenating) the content of one or more fields present in the base.

To provide an example, a user may submit a prompt request that states, “Please help me generate a prompt that performs classification operations on data in third-party bases.” In response, the Gen-AI module 220 generates a prompt based on that natural language request, provides it to a Gen-AI model, and the Gen-AI model provides a set of data that is responsive to the request. An example of that output is omitted, but the set of data, in this example, would be a set of words that would act as a prompt to generate a function that performs “classification operations on data in third-party bases” within the environment 100.

The Gen-AI module 220 determines a prompt for the Gen-AI model based on the prompt request. Similar to above, the determined prompt may also be based on additional contextual information such as, e.g., other information derived from the base and/or information about the submitting user (and other additional information described above). Additionally, or alternatively, the generative AI module 220 may recommend one or more prompts for the user to submit (e.g., based on prior prompts submitted by the user and the information in one or more fields).

Given this, at a high level, the prompt generation module 222 interprets a user's intent given various base data and other additional information and generates a prompt which is transmitted to a Gen-AI model. This generated prompt may be stored in an intermediate format such that the Gen-AI module 220 can then send that same prompt interpolated with the appropriate data for every row in the database. The intermediate format can also include contextual information and any relevant additional information.

To provide an example, a user can input “Translate it to French.” The prompt generation module 222 interprets the intent of that input and generates an intermediate format with knowledge about the base and context. For instance, the prompt generation module 222 may interpret the users input as “‘You are a translator, you will be provided with data in the following field which the user has named ‘To Translate’. [Data in the field ‘To Translate’]. Translate the data in the ‘To Translate’ field to French. Replace the current data in the ‘To Translate’ field with the generated French Translation.” Note that in this case the prompt may additionally include: best practices on writing a prompt, knowledge about the specific field+metadata (it's “Name” vs how the user described it as “it”) based on the context of the users request (where it originated, other fields available in the base, etc.), as well as a token representing where data should be inserted. This allows the prompt to be more consistent across multiple rows, and less susceptible to attacks (e.g., prompt injection).

In an embodiment, the prompt generation module 230 receives a prompt request by a user, determines both a prompt and improved prompt based on the prompt request, and transmits the prompt and improved prompt to the Gen-AI model. Both the prompt and the improved prompt request a desired functionality but use different prompt language or structure. The Gen-AI model generates a set of data providing the requested functionality based on both the prompt and the improved prompt. The prompt generation module 230 may present the responsive information generated by both the prompt and the improved prompt to the user for comparison.

In some cases, the two sets of responsive information may be presented with markup indicating differences between them. It should be appreciated that although a single improved prompt is described, a similar process may be used to generate multiple prompts and display the corresponding responsive to the user. In some embodiments, the prompt generation module 230 may compare the results generated by multiple prompts, calculate a set of difference metrics indicating how different the responses are (e.g., using a clustering algorithm such as K-means clustering) and present a subset of the results that are most different from each other.

The server 110 includes a categorization module 224. The categorization module 240 generates a data set that automatically categorizes, or generates functions that categorize, data in bases in the bases datastore 270 based on a natural language request from a client device 140 (e.g., as input by a user). In other words, in one embodiment, the functionality described in a request is, at a high level, to categorize data within the environment 100.

There are several ways in which the Gen-AI module 220 may categorize the data.

In a first example, the categorization module 224 may generate a prompt configured to categorize a set of data. In this case, the Gen-AI module 220 may generate a prompt with the data to be categorized and the categories to sort the data into, provide the prompt to the Gen-AI model, and receive a data set with the categorized data in response. The prompt may include any additional information to appropriately categorize information within the environment. In some cases, the Gen-AI model may generate categories into which the data is categorized.

In a second example, categorization module 224 may generate a prompt configured to generate a function for categorizing data in a base or bases within the environment 100. In this case, the Gen-AI module 220 may generate a prompt with a request to generate a function that categories data within the environment, provide the prompt to the Gen-AI model, and receive a function that categorizes data in response. In an example, the Gen-AI model generates a clustering algorithm that identifies clusters within the bases datastores 270. In some cases, the clustering algorithm may be stored and accessed at a later time without generating a new algorithm. The categorization module 224 applies the clustering algorithm to identify clusters within data in bases datastore 270 and categorizes the data. In some embodiments, when new data is added (e.g., entered into a field, a new based is added), it can be automatically categorized based on which cluster the algorithm determines it belongs in. For example, in a database that receives customer feedback from a webform, each comment received may be automatically categorized and forwarded to the appropriate team for handling.

In a third example, the categorization module 224 may implement a sorting or categorization algorithm based on representations of the data in semantic space. For example, the categorization module 224 may generate an embedding representing a base, bases, a portion of a base, or a portion of bases within the environment. The embedding is a higher-dimensional representation of the data from which the embedding was generated. The categorization module may categorize additional data within the environment using the generated embeddings and may do so in a variety of ways.

In a first example, the categorization module 224 may determine a similarity between embeddings. The categorization module 224 may quantify the similarity between embedding (e.g., Euclidean distance, cosine similarity, etc.), and determine that various embeddings are in the same category based on the quantification (e.g., a similarity above a threshold, less than a threshold distance, etc.).

In a second example, the categorization module 224 may initially determine a set of categories. Each category corresponds to data in a similar structural area in the environment (e.g., the same field in a base). Because the data all originates in a similar structural area, the embeddings representing that data are similar. In turn, the categorization module 224 can categorize data into the categories by comparing an embedding for information being categorized to the embeddings corresponding to a category (e.g., using k-means clustering). More simply, the categorization module will assign a category to a piece of data if its embedding is similar to embeddings for data already having that category (using any of the various quantification approaches described herein).

Other examples are also possible. However, in whatever example enabled by the categorization module 224, the Gen-AI module 220 can leverage the Gen-AI model to assist with the categorization. For instance, the Gen-AI module 220 may employ the Gen-AI model to generate embeddings, compare embeddings, categorize based on embeddings etc.

In an embodiment, the categorization module provides the categorizations of data as a recommended categorization. The recommended categorizations generated by the categorization module 240 may be presented to the user for confirmation. If the user overrides the recommendation generated by the categorization module 240, this may be used as additional training data to retrain the categorization model.

In an embodiment, new categories can be recommended by identifying clusters that appear to be distinct from existing categories. For example, in the customer feedback example use case, the categorization module 240 may identify that there is a category of feedback that many customers provide that is not well-represented in the current taxonomy of categories and suggest adding a new category for this subset of the received feedback. In some cases, this approach may be used to generate a taxonomy of categories for initially entirely uncategorized data.

The server 110 includes a field manipulation module 226. The field manipulation module 226 generates a set of data configured to add, remove, or modify data, structure, or relationships in a base or bases (“manipulation data sets”) based on a natural language request received from a client device 140 (e.g., as input by a user). In other words, in one embodiment, the functionality described in a request is to, at a high level, modify a base in some manner.

Manipulation data sets can modify a base in a variety of ways. For example, a manipulation data set can (1) add, remove, or modify structured data from a base, (2) add, remove or modify a structural relationship in a base or between bases (e.g., functions, dependencies, etc.), (3) add, remove, or modify a structure of the base or bases (e.g., elements, fields, rows, etc.), (4) add, remove, or modify a data type in a base, etc. The manipulation data sets may also provide a combination of any of these example functionalities.

To provide some examples, a natural language request may request a translation of text-based data to its numerical representation and to insert the numerical data into the base next to the text-based number, manipulating data in a field in a first base based on the labels of data in a field from a second base that depends on a third base, truncating the numerical representation to 3 significant digits, comparing the text in a first field of a first base to a second base to determine the number of matching or approximately matching entries, etc. There are many more examples. Whatever the case, the Gen-AI module 220 generates a prompt based on the natural language requesting a functionality. The prompt may also include information about the base, contextual information about the user, contextual information about the use case, etc.

The Gen-AI module 220 transmits the generated prompt to the Gen-AI model, and the Gen-AI model generates a set of data providing the requested functionality. The Gen-AI module 220 provides the data for display to and/or access by the client device 140 as described above. In some example embodiments, the Gen-AI module 220 may present at least some of the generated data to the user for review. The user may edit the generated data and the edited data may be populated to the base as structured data. In this case, the user may flag the edited data—with the flag indicating whether the edited data populated to the base may be modified in the future by an additional request and generation. So, for instance, a user may indicate that they do not want the edited data to be manipulated by Gen-AI module 220 in the future. When the Gen-AI module 220 generates a set of data that would normally manipulate the flagged data it will not do so because of the flag.

The server 110 includes a function generation module 228. The function generation module generates 228 one or more functions based on a natural language request received from a client device 140 (e.g., as input by a user). In other words, in one embodiment, the functionality described in a request is to generate a function for the base. A function is one or more operations the server 110 may apply to one or more elements of a structured data to generate one or more additional data elements.

As a simple example, the request may be to “Generate a function that adds Field 1 in Base 1 to Field 2 in Base 1.” In turn, the function generation module generates a prompt configured to determine this function using a Gen-AI model, transmits the prompt to the Gen-AI model, and receives the set of data providing the functionality in response. In this case the functionality is, for example “ADD([Field1, Base1], [Field2, Base1])”. The function generation module 228 may automatically implement the requested function or may provide the function for display to a client device 140. It is also possible to generate data in a second base.

As a more complex example, the request may be to “Generate a function that determines a standard deviation of all temperatures in Fields labelled with both “Winter” and a “Year” between 1980 and 2003 and compare that to an average for Fields labelled “Summer” with the same period.” In turn, the function generation module generates a prompt configured to determine this function using a Gen-AI model, transmits the prompt to the Gen-AI model, and receives the set of data providing the functionality in response. Of course, the function will be more complex than the one provided above.

Similar to above, when generating a prompt for the Gen-AI model to generate a function, the Gen-AI module 220 may provide additional information when encoding the prompts. For instance, the Gen-AI module 220 may generate a prompt with a representation of the functional syntax of the base and/or the environment. To illustrate, as an example, the Gen-AI module 220 may generate a prompt with a representation of the “ADD”, “MULTIPLY”, “SORT”, etc. function which enable, when appropriately arranged, aggregate functions with greater functionality. In this manner, the Gen-AI model can generate functions that provide requested functionality using syntax configured for the base and/or server 110.

The databases 250 may be stored on one or more non-transitory computer-readable media. The databases 250 may include fields that use one or more primitives stored in a primitives datastore 260 (on the same or a different non-transitory computer-readable media as the databases 250). For example, primitives may include an automation that automatically populates fields on the submission of new data in an input field. This automatic population may include providing newly generated data to the generative AI model and adding the responsive data to a generative AI field in the database.

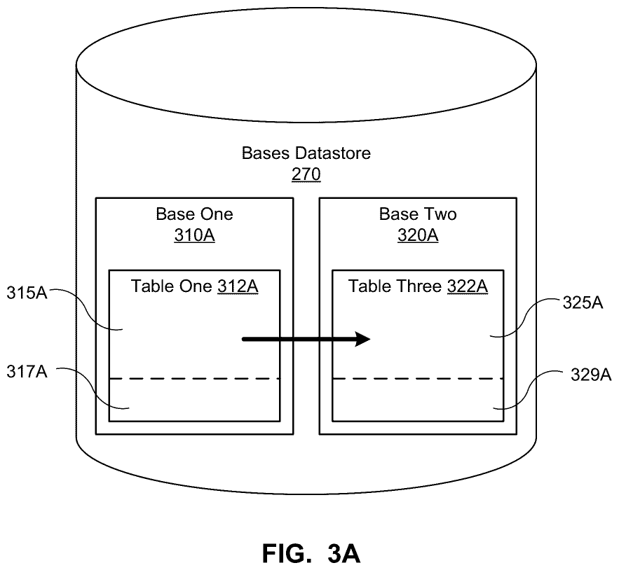

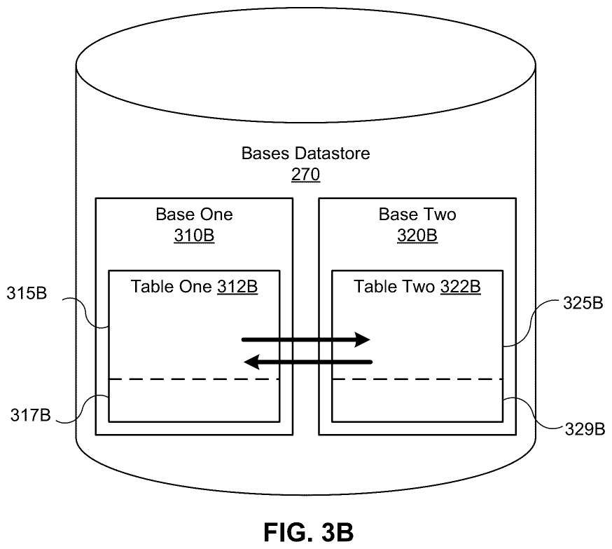

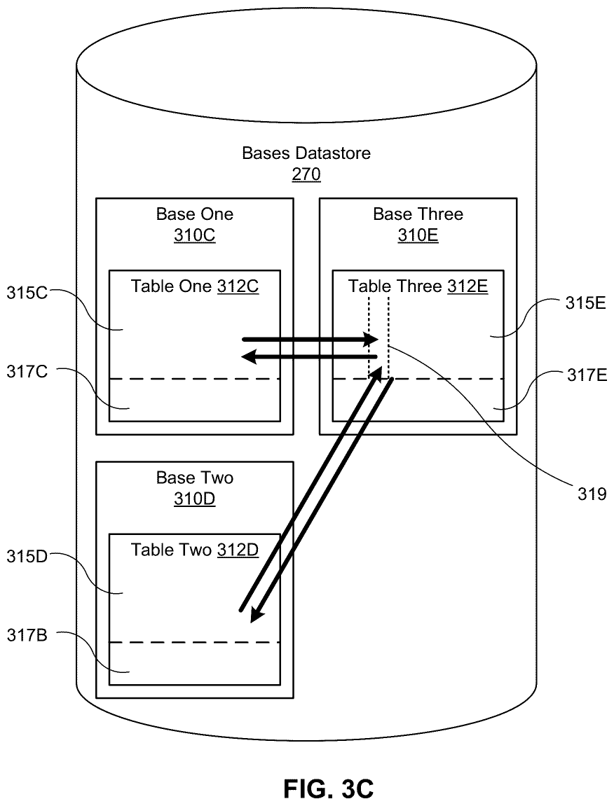

FIG. 3A illustrates a dependency of two tables of two databases in the bases datastore, according to one embodiment. The dependency allows for one-way synchronization between the bases. That is, one or more structural relationships of the data structure of the first base indicate that data in the first base affect the data or data structure of the second base.

In the embodiment shown, the bases datastore 270 includes base one 310A and base two 320B. In practice, the bases datastore 270 will likely include many more (e.g., hundreds, thousands, or even millions of) bases. Base one 310A includes table one 312A, which has a synchronized portion 315A and an unsynchronized portion 317A. Base two 320A includes table two 322A, which includes a synchronized portion 325A (which mirrors the synchronized portion 315 of table one 312 except for any differences that arose since the previous synchronization operation) and an enriched portion 329A. The enriched portion 329A may include data added by users of base two 320A, data synchronized from a third table, or both. Notably, while not illustrated as such, the synchronized and/or unsynchronized portions of each table may be the entire table, a portion of the table, or none of table, depending on the configuration of the bases.

FIG. 3B illustrates a dependency of two tables of two databases in the bases datastore, according to one embodiment. The dependency allows for one-way synchronization between the bases. That is, one or more structural relationships of the data structure of the first base indicate that data in the first base affects the data or data structure of the second base, and/or one or more structural relationships of the data structure of the second base indicate that data in the second base affects the data or data structure of the first base.

In the embodiment shown, the bases datastore 270 includes base one 310B and base two 320B. In practice, the bases datastore 270 will likely include many more (e.g., hundreds, thousands, or even millions of) bases. Base one 310B includes table one 312B, which has a synchronized portion 315B and an unsynchronized portion 317B. Base two 320B includes table two 322B, which includes a synchronized portion 325B and an unsynchronized portion 329B. The synchronized portions 315B, 325B may include data added by users of base one 310B and base two 320B, data synchronized from a third table, or both. In this illustrated configuration, the server 110 is configured to both (1) synchronize data in the synchronized portion 315B of table one 312B in base one 310B to its corresponding synchronized portion 325B in table two 322B of base two 320B, and (2) synchronize data in the synchronized portion 325B in table two 322B of base two 322B to its corresponding synchronized portion 315B in table one 312B of base one 310B.

FIG. 3C illustrates a dependency of a single table in a data base on two tables of two databases in the bases datastore, according to one embodiment. The dependency allows for one-way synchronization or two-way synchronization between multiple bases. That is, one or more structural relationships of the data structure of the third base indicate that data in the first base and the second base affects the data or data structure of the third base, and/or one or more structural relationships of the data structure of the first and/or second base indicate that data in the first and/or second base affects the data or data structure of the third base.

In the embodiment shown, the bases datastore 270 includes base one 310C, base two 310D, base three 410C, and a field name datastore 420. Base one 310C includes table one 312C, which has a synchronized portion 315C and an unsynchronized portion 317C. Base two 310D likewise includes table two 312D, which has a synchronized portion 315D and an unsynchronized portion 317D. The field name datastore 420 stores mappings between potential field names that have a high likelihood of being synonymous (e.g., “first name” and “given name”). The bases datastore 270 may include additional bases or tables, depending upon the embodiment.

Base three 410C includes table three 312E, which includes a synchronized portion 315E and an enriched portion 317E. The enriched portion 317E may include data added by users of base two 310D, data synchronized from a fourth table, or both. For example, the server 110 may receive user input data (e.g., data that a user input to a client device 140 and sent to the server 110) specifying additional one or more rows or columns to add to table three 410C.

In the illustrated example, table three 312E includes a column 319 that synchronizes data from two sources, table one 312C and table two 312D. For example, column 319 includes ten records total, six received from table one 312C and four from table two 312D. A user administrating table three 312E (e.g., using a client device 140) sets table one 312C as the primary source. Depending upon the embodiment, the primary source may be automatically set by the server 110, e.g., based on which source is first synchronized to the column 319, or which source provides the most records to the column 319; the automatically set primary source may be updated by the user, in some embodiments. Source tables other than the primary source may be considered secondary sources.

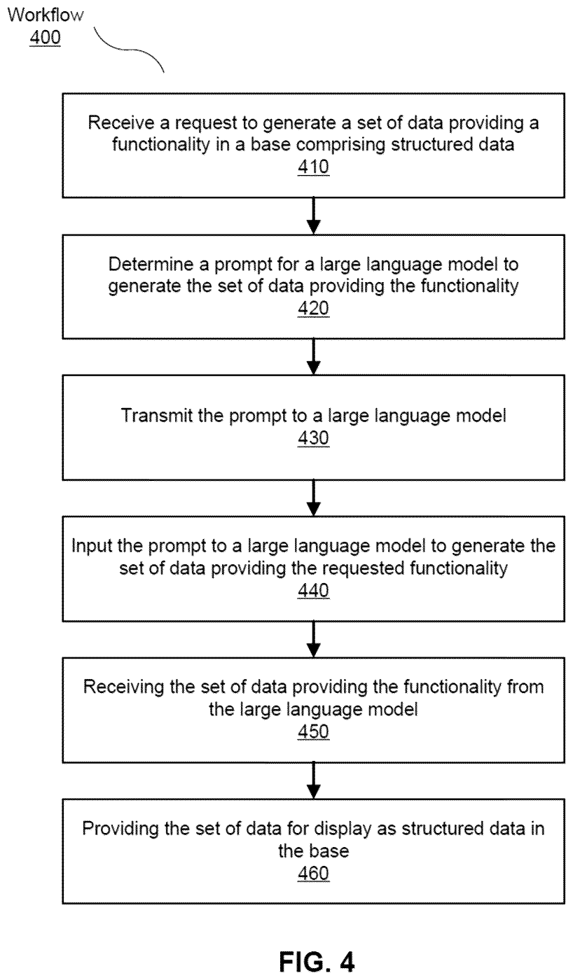

FIG. 4 illustrates a first example workflow diagram for a computer-implemented method for generating data for a base, according to one embodiment. The workflow 400 may include additional or fewer steps, and/or the steps may occur in a different order. Moreover, one or more of the steps may be omitted or repeated.

In the illustrated example, a client device (e.g., client device 140) is accessing a server (e.g., server 110) in the environment (e.g., environment 100). The server includes a bases datastore (e.g., bases datastore 270) with a variety of bases. The bases in the bases datastore are data objects comprising structured data. The data object making up the base, in other words, comprises data having a structure, structural relationships, data types, dependencies, etc.

The server is configured with a Gen-AI module (e.g., Gen-AI module 220) configured to provide a field in bases which provided generative AI assistance to users interacting with a base. The functionality may include, for example, prompt generation, data categorization, field manipulation, and function generation. The Gen-AI module may interact with a local or third-part Gen-AI model that provides generated datasets that provide the functionality.

To illustrate, as shown in the example workflow 400, the server (e.g., a computing device) receives 410 a request to generate a set of data providing a functionality. For example, a user may type a request into a field of the base (or a field linked to or accessing the base). The request is a natural language request for the functionality. The natural language request includes both content and context that may be relevant in generating prompts for a Gen-AI model to provide the functionality. In some example, the functionality requested in the natural language request uses a portion of the structured data of the base (e.g., references a field, or base, or element, etc.).

The server determines 420 a prompt for the Gen-AI model (e.g., a large language model) to generate the set of data providing the functionality. To do so, the server may generate a prompt with a representation of the natural language request for the functionality, and the portion of the structured data used in the natural language request. In some configurations, the server may also provide additional information into the prompt such as a structure of the base, structural relationships in the base, and data types of the structured data in the base. The additional information aids the Gen-AI model to generate data sets responsive to the request.

The server transmits 430 the prompt to the Gen-AI model. The Gen-AI may be operated locally on a client device, the server, or a third-party server depending on the circumstances.

The Gen-AI model encodes the prompt, inputs 440 the encoded prompt, generates output, and decodes the output into the set of data providing the requested functionality. In some instances, the server encodes the prompt and/or decodes the output rather than the Gen-AI model.

The Gen-AI model transmits the set of data to the server, and the server receives 450 the set of data. The set of data provides the functionality requested in the natural language input.

The server provides 460 the set of data for display as structured data in the base. Providing the set of data for display may include adding or modifying data in the base or a dependent base depending on the request and the output.

### Computing System Architecture

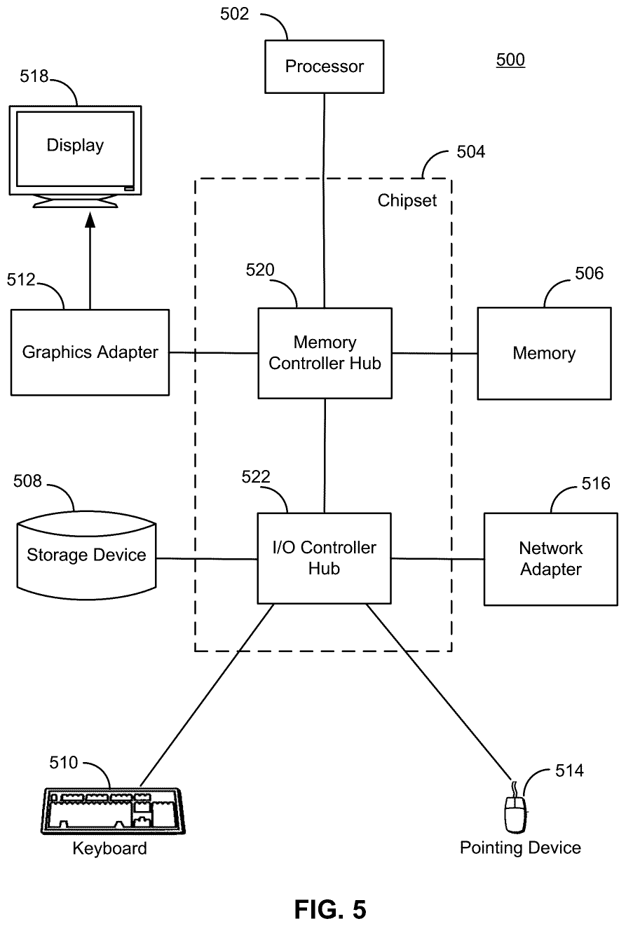

FIG. 5 is a block diagram of an example computer 500 suitable for use as a server 110 or client device 140, according to one embodiment. The example computer 500 includes at least one processor 502 coupled to a chipset 504. The chipset 504 includes a memory controller hub 520 and an input/output (I/O) controller hub 522. A memory 506 and a graphics adapter 512 are coupled to the memory controller hub 520, and a display 518 is coupled to the graphics adapter 512. A storage device 508, keyboard 510, pointing device 514, and network adapter 516 are coupled to the I/O controller hub 522. Other embodiments of the computer 500 have different architectures.

In the embodiment shown in FIG. 5, the storage device 508 is a non-transitory computer-readable storage medium such as a hard drive, compact disk read-only memory (CD-ROM), DVD, or a solid-state memory device. The memory 506 holds instructions and data used by the processor 502. The pointing device 514 is a mouse, track ball, touchscreen, or other type of pointing device, and may be used in combination with the keyboard 510 (which may be an on-screen keyboard) to input data into the computer system 500. The graphics adapter 512 displays images and other information on the display 518. The network adapter 516 couples the computer system 500 to one or more computer networks, such as network 170.

The types of computers used by the entities of FIGS. 1 and 2 can vary depending upon the embodiment and the processing power required by the entity. For example, the server 110 might include multiple blade servers working together to provide the functionality described. Furthermore, the computers can lack some of the components described above, such as keyboards 510, graphics adapters 512, and displays 518.

### Additional Considerations

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for providing a database with integrated generative AI. Thus, while particular embodiments and applications have been illustrated and described, it is to be understood that the described subject matter is not limited to the precise construction and components disclosed. The scope of protection should be limited only by any claims that may ultimately issue.

What is claimed is:

1. A computer-implemented method for generating data for a base, the computer-implemented method comprising:
receiving, by a computing device, a request to generate a set of data providing a functionality in a base comprising structured data, the request comprising a natural language request for the functionality using a least a portion of the structured data of the base;
determining, by the computing device, a prompt for a large language model to generate the set of data providing the functionality, wherein the prompt comprising a representation of:
the natural language request for the functionality;
the portion of the structured data used in the natural language request,
a structure of the base;
structural relationships in the base; and
data types of the structured data in the base;
in response to transmitting the prompt to the large language model, receiving, by the computing device, the set of data providing the functionality from the large language model; and
transmitting the set of data for display as structured data in the base.

2. The computer-implemented method of claim 1, comprising
determining, using the prompt at a network system hosting the large language model, the set of data providing the functionality, the large language model configured to:
interpret the natural language request for the functionality using at least the structured data,
identify contextual relationships between the functionality and one or more of the structure of the structured data, the structural relationships of data in the structured data, and data types of the structured data, and
determine the set of data providing the functionality based on the contextual relationships.

3. The computer-implemented method of claim 1, further comprising:
receiving, by the computing device, a selection of the large language model from a plurality of large language models, wherein the plurality of large language models is provided to a client device generating the prompt; and
wherein generating the prompt for the large language model accounts for a configuration of the selected large language model.

4. The computer-implemented method of claim 1, wherein the natural language request comprises one or more data objects representing the portion of the structured data of the base.

5. The computer-implemented method of claim 1, comprising:
receiving, at the computing device, an edit to the set of data displayed as structured data of the base;
generating, at the computing device, a flag for the set of data as manipulated data based on the edit;
responsive to receiving an additional request to modify the set of data, determining an additional prompt and modifying the set of data based on the generated flag.

6. The computer-implemented method of claim 1, wherein the structure of the structured data comprises one or more of:
a plurality of elements in the base, each element comprising structured data;
a set of rows in the base, the set of rows comprising one or more of the plurality of elements;
a set of fields in the base, the set of fields comprising one or more of the plurality of elements;
a label for each element of the plurality of elements, each row of the set of rows, and each field of the set of fields; and
a size of the base.

7. The computer-implemented method of claim 1, wherein the base comprises a plurality of elements in a set of fields and a set of rows, and the structural relationships of data in the structured data comprise one or more of:
a dependency of a first field in the set of fields on a second field in the set of fields;
a dependency of a first row in the set of rows on a second row in the set of rows;
a dependency of a first element of the plurality of elements on a second element of the plurality of elements; and
one or more logical functions governing dependencies in the structural data.

8. The computer-implemented method of claim 1, wherein the prompt comprises a relationship between the base and one or more additional bases; wherein each of the one more additional bases depend on structured data of the base.

9. The computer-implemented method of claim 8, wherein the set of data is propagated to the one or more additional bases that depend on the structured data of the base.

10. The computer-implemented method of claim 1, wherein the prompt comprises a representation of a relationship between the base and one or more additional bases; wherein the structured data of the base depend on structured data of the one or more additional bases.

11. The computer-implemented method of claim 10, wherein the set of data is propagated to the one or more additional bases that depend on the structured data of the base.

12. The computer-implemented method of claim 1, wherein:
the base comprises a field, and the request to generate the set of data providing the functionality in the base is received as an input to the field; and
the generated prompt is associated with the field.

13. The computer-implemented method of claim 12, wherein the received set of data is displayed in the field before being displayed as structured data in the base.

14. The computer-implemented method of claim 1, wherein the base comprises a data generation assistant function, and the request to generate the set of data providing the functionality in the base is received at the data generation assistant.

15. The computer-implemented method of claim 14, wherein the received set of data is displayed by the data generation assistant function before being displayed as structured data in the base.

16. The computer-implemented method of claim 1, wherein the functionality is categorizing data input into the base.

17. The computer-implemented method of claim 1, wherein the functionality is generating a function that manipulates a first portion of the structured data in the base based on a second portion of the structured data in the base.

18. The computer-implemented method of claim 1, wherein the functionality is translating a first portion of the structured data in the base.

19. A system comprising:
one or more processors; and
a non-transitory computer readable storage medium comprising computer program instructions for generating data for a base, the computer program instructions, when executed by the one or more processors, causing the one or more processors to:
receive, at the system, a request to generate a set of data providing a functionality in a base comprising structured data, the request comprising a natural language request for the functionality using a least a portion of the structured data of the base;
determine, by the system, a prompt for a large language model to generate the set of data providing the functionality, wherein the prompt comprising a representation of:
the natural language request for the functionality;
the portion of the structured data used in the natural language request,
a structure of the base;
structural relationships in the base; and
data types of the structured data in the base;
in response to transmitting the prompt to the large language model, receive, at the system, the set of data providing the functionality from the large language model; and
transmit, to a client device, the set of data for display as structured data in the base.

20. A non-transitory computer readable storage medium comprising computer program instructions for generating data for a base, the computer program instructions, when executed by the one or more processors, causing the one or more processors to:
receive, at a computing device, a request to generate a set of data providing a functionality in a base comprising structured data, the request comprising a natural language request for the functionality using a least a portion of the structured data of the base;
determine, at the computing device, a prompt for a large language model to generate the set of data providing the functionality, wherein the prompt comprising a representation of:
the natural language request for the functionality;
the portion of the structured data used in the natural language request,
a structure of the base;
structural relationships in the base; and
data types of the structured data in the base;
in response to transmitting the prompt to the large language model, receive, at the computing device, the set of data providing the functionality from the large language model; and
transmit, to a client device, the set of data for display as structured data in the base.
